(19) United States
(12) Patent Application Publication
(10) Pub. No.: US 2024/0196358 A1
(43) Pub. Date: Jun. 13, 2024

(54) POSITIONING ENHANCEMENT MECHANISM

(71) Applicant: Nokia Technologies Oy, Espoo (FI)

(72) Inventors: Tao TAO, Shanghai (CN); Yan MENG, Shanghai (CN); Diomidis MICHALOPOULOS, Munich (DE); Mikko SAILY, Espoo (FI); Timo KOSKELA, Oulu (FI)

(21) Appl. No.: 18/553,690

(22) PCT Filed: Apr. 6, 2021
(86) PCT No.: PCT/CN2021/085588

§ 371 Date: Oct. 2, 2023

(51) Int. Cl. H04W 64/00; H04W 28/26; H04W 72/1268; H04W 74/0836; H04W 76/20

(52) U.S. Cl. CPC H04W 64/00; H04W 28/26; H04W 72/1268; H04W 74/0836; H04W 76/20

(57) ABSTRACT

Embodiments of the present disclosure relate to methods, devices, apparatuses, and computer readable medium for positioning enhancement mechanism. A first device determines that a third device is to transmit a positioning related message in a non-connected state. The first device transmits assistance information to a second device serving the third device. The assistance information comprises at least one of data size and a transmission periodicity for the positioning related message. By means of the assistance information, the base stations are provided with proactive knowledge of the positioning related message. In this way, the base station is capable of determining appropriate configurations for the SDT procedure. The terminal device may then transmit the positioning related message in the RRC NON-CONNECTED state via the SDT. As such, the efficiency of SDT procedure can be improved, while avoiding segmentation or subsequent transmission of the positioning report.

### FIELD

Embodiments of the present disclosure generally relate to the field of telecommunication and in particular, to devices, methods, apparatus and computer readable storage media of positioning enhancement mechanism.

### BACKGROUND

For a terminal device (e.g., UE) in radio resource control (RRC) connected (e.g., RRC_CONNECTED) state, it is easily to be positioned in a mobile communication network with a series of location management operations. For example, a network node in charge of the location management function, which may be referred to as LMF, may request the terminal device to transmit a positioning measurement report by sending LTE positioning protocol (e.g., LPP) request location information. In this request, the LMF may indicate a type of the measurement report, such as, a triggering based report or a periodic report, a reporting amount, a reporting interval, which is especially for the periodic report, and the like. Such location information is transparent to a serving base station (e.g., gNB) of the terminal device, and thus the LMF may further provide it to the serving base station and the access and mobility management function (AMF) node.

As communication technologies evolve to the fifth generation new radio, which is also referred to as 5G NR, a new RRC state, i.e., RRC inactive state, has been introduced to adapt to new application scenarios and service characteristics. In RRC_INACTIVE state, the terminal device is capable of operating in a low power consumption manner, like a “sleep” mode, while infrequent and small data traffic is still allowed to be received or transmitted. The context of the terminal device is kept at the last serving base station, and the terminal device may move within a radio access network (e.g., RAN) based notification area (e.g., RNA) without notifying the RAN. As such, RRC_INACTIVE state may reach a trade-off between the transmission delay, power consumption and signalling overheads. The RNA may cover several cells provided by multiple base stations, and in some cases, the terminal device may even move outside the RNA. It may increase the difficulty or accuracy of positioning the terminal device.

### SUMMARY

In general, example embodiments of the present disclosure provide a solution for positioning enhancement mechanism.

In a first aspect, there is provided a first device. The first device comprises: at least one processor; and at least one memory including computer program codes. The at least one memory and the computer program codes are configured to, with the at least one processor, cause the first device to: determine that a third device is to transmit a positioning related message in a non-connected state; and transmit assistance information to a second device serving the third device, the assistance information comprising at least one of data size and a transmission periodicity for the positioning related message.

In a second aspect, there is provided a second device. The second device comprises: at least one processor; and at least one memory including computer program codes. The at least one memory and the computer program codes are configured to, with the at least one processor, cause the second device to: receive assistance information from a first device, the assistance information comprising at least one of a data size and a transmission periodicity for a positioning related message to be transmitted by a third device in an non-connected state; determine a configuration for the positioning related message based on the assistance information; and transmit the configuration to the third device.

In a third aspect, there is provided a third device. The third device comprises: at least one processor; and at least one memory including computer program codes. The at least one memory and the computer program codes are configured to, with the at least one processor, cause the third device to: receive, from a second device, a configuration for a positioning related message to be transmitted by the third device in an non-connected state, the configuration being determined at the second device based on assistance information received from a first device, the assistance information comprising at least one of a data size and a transmission periodicity for the positioning related message; and transmit, in the non-connected state and to the second device, the positioning related message based on the configuration.

In a fourth aspect, there is provided a fourth device. The fourth device comprises: at least one processor; and at least one memory including computer program codes. The at least one memory and the computer program codes are configured to, with the at least one processor, cause the fourth device to: receive assistance information from a first device, the assistance information comprising at least one of a data size and a transmission periodicity for a positioning related message to be transmitted by a third device in an non-connected state; and reserve a resource based on the assistance information.

In a fifth aspect, there is provided a method. The method comprises: determining, at a first device, that a third device is to transmit a positioning related message in an non-connected state; and transmitting assistance information to a second device serving the third device, the assistance information comprising at least one of a data size and a transmission periodicity for the positioning related message.

In a sixth aspect, there is provided a method. The method comprises: receiving, at a second device and from a first device, a configuration for transmission of first reference signals, the configuration being determined by the first device based on information regarding an angle of departure from a location management device, the angle of departure being expected for the transmission of the first reference signals from a second device; and transmitting, based on the configuration, the first reference signals for positioning of the second device.

In a seventh aspect, there is provided a method. The method comprises: receiving, at a third device and from a second device, a configuration for a positioning related message to be transmitted by the third device in an non-connected state, the configuration being determined at the second device based on assistance information received from a first device, the assistance information comprising at least one of a data size and a transmission periodicity for the positioning related message; and transmitting, in the non-connected state and to the second device, the positioning related message based on the configuration.

In a eighth aspect, there is provided a method. The method comprises: receiving, at a fourth device, assistance information from a first device, the assistance information comprising at least one of a data size and a transmission periodicity for a positioning related message to be transmitted by a third device in an non-connected state; and reserving a resource based on the assistance information.

In an ninth aspect, there is provided a first apparatus. The first apparatus comprises: means for determining that a third device is to transmit a positioning related message in a non-connected state; and means for means for transmitting assistance information to a second device serving the third device, the assistance information comprising at least one of data size and a transmission periodicity for the positioning related message.

In a tenth aspect, there is provided a second apparatus. The second apparatus comprises: means for receiving assistance information from a first device, the assistance information comprising at least one of a data size and a transmission periodicity for a positioning related message to be transmitted by a third device in an non-connected state; means for means for determining a configuration for the positioning related message based on the assistance information; and means for means for transmitting the configuration to the third device.

In an eleventh aspect, there is provided a third apparatus. The third apparatus comprises: means for receiving, from a second device, a configuration for a positioning related message to be transmitted by the third device in an non-connected state, the configuration being determined at the second device based on assistance information received from a first device, the assistance information comprising at least one of a data size and a transmission periodicity for the positioning related message; and means for transmitting, in the non-connected state and to the second device, the positioning related message based on the configuration.

In a twelfth aspect, there is provided a fourth apparatus. The fourth apparatus comprises: means for receiving assistance information from a first device, the assistance information comprising at least one of a data size and a transmission periodicity for a positioning related message to be transmitted by a third device in an non-connected state; and means for reserving a resource based on the assistance information.

In a thirteen aspect, there is provided a non-transitory computer readable medium. The non-transitory computer readable medium comprises program instructions for causing an apparatus to perform the method according to the fifth, sixth, seventh, or eighth.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented;

FIG. 2 shows a signaling chart illustrating a positioning process for the terminal devices in non-connected state according to some example embodiments of the present disclosure;

FIG. 3 illustrates a flowchart of an example method for positioning implemented at a first device according to example embodiments of the present disclosure;

FIG. 4 illustrates a flowchart of an example method for positioning implemented at a second device according to example embodiments of the present disclosure;

FIG. 5 illustrates a flowchart of an example method for positioning implemented at a third device according to example embodiments of the present disclosure;

FIG. 6 illustrates a flowchart of an example method for positioning implemented at a fourth device according to example embodiments of the present disclosure

FIG. 7 illustrates a simplified block diagram of an apparatus that is suitable for implementing example embodiments of the present disclosure; and

FIG. 8 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

With respect to the positioning process in RRC_CONNECTED state, the terminal device may request UL resource per each of the reporting occasions via a scheduling request to the serving base station. When entering RRC NON-CONNECTED state, including RRC_INACTIVE state and RRC_IDLE state, the serving base station may lack knowledge about when and how much resource the terminal device needs to transmit the positioning report. In the RRC_INACTIVE state, Uplink (UL)/Downlink (DL) transmissions are allowed via a small data transmission (SDT) procedure, which can be achieved based on a Random Access Channel (RACH) procedure or configured grant (CG). In view of this, the SDT may be used for positioning the terminal device in the non-connected state.

Typically, the serving base station configures a data size threshold for the terminal device to determine whether to transmit UL data via the SDT procedure. More specifically, if the data size of UL data is smaller than the data size threshold (e.g., 1000 bits), the terminal device may determine to use SDT to transmit the UL data. Otherwise, the terminal device may not use SDT for transmitting data in RRC_INACTIVE state. Subsequent data transmissions are also allowed in SDT. In other words, the terminal device may transmit the traffic of a larger size to the base station via multiple SDT transmissions.

In such a static configuration manner, the base station may not be aware of how much data is to be transmitted from the terminal device, and thus it is hard to assign appropriate physical uplink shared channel (e.g., PUSCH) resource for the UL SDT transmission. If the base station assigns insufficient resource for the positioning measurement report, report segmentation is required. However, the segmentation will cause additional delay and additional power consumption. On the other hand, if the serving base station assigns PUSCH resource according to a maximum allowed data size, that is, based on the threshold, it may cause potential resource waste. For example, if the terminal device does not have that much data to be transmitted, padding will be applied on the SDT, leading to a low efficiency.

In order to solve the above and other potential problems, embodiments of the present disclosure provide an improved solution for positioning. In the solution, assistance information is provided to the serving network device to assign appropriate resources for SDT. The assistance information may indicate at least one of the data size, amount, periodicity, interval associated with the positioning report and the like. The serving base station then determines SDT configuration suitable for positioning report based on the assistance information. With the SDT configuration, the terminal device can transmit a positioning related message in a non-connected state. Such a solution is applicable for both UE assisted positioning and UE based positioning. Of course, this solution can also be applied for transmitting other information from the terminal device to the LMF in the non-connected state.

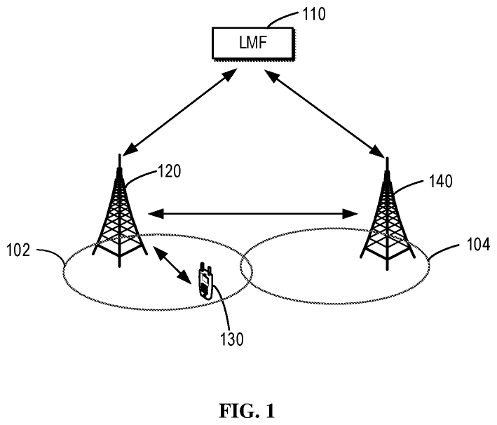

FIG. 1 illustrates an example communication network 100 in which embodiments of the present disclosure can be implemented. As shown in FIG. 1, the communication network 100 includes a first device 110, a second device 120, a third device 130 and a location management device 140.

The first device 110 may be implemented as LMF in a core network. Of course, the first device 110 may also be implemented in a radio access network (RAN), and in this case, it may be referred to as a local management component (LMC). The first device 110 may determine location information of the terminal devices and provide positioning service to terminal devices and base stations. For example, the first device 110 may be requested to position the third device 130 by the AMF or the second device 120, and then initiate a positioning procedure.

The first device 110 may communicate with the second device 120 and the fourth device 140. In some example embodiments, the first device 110 may transmit assistance information associated with the positioning report to the second device 120 and the fourth device 140. For example, the assistance information may include, but not limited to, a data size or a transmission periodicity for the positioning related message. Such assistance information may be helpful for configuring suitable SDT configurations by the second device 120 and the fourth device 140.

The second device 120 may be a network device (e.g., gNB) and provide a serving cell 102 for the third device 130. In a case where the third device 130 switches from the RRC_CONNECTED state to RRC NON-CONNECTED state, the second device 120 acts as the last base station that serves the third device 130, and thus maintain the context of the third device 130.

The fourth device 140 may be another network device (e.g., gNB) or a transmission and reception point (TRP), and provide a neighbor cell 104 for the third device 130. The second device 120 and the fourth device 140 may be within a same RAN-based notification area (RNA), and the third device 130 may move outside the coverage of the cell 102 and inside the coverage of the cell 104.

The third device 130 may be a terminal device located within the RNA. For example, the third device 130 may move within the coverage of the RNA. As shown in FIG. 1, the third device 130 may be initially served by the second device 120, and then served by the fourth device 140.

In the example embodiments, the third device 130 may switch between different states, for example, from the RRC_CONNECTED state to the RRC_INACTIVE state. In the RRC inactive state, the third device 130 may transmit data via SDT procedure. For example, the second device 120 may transmit the SDT configuration to the third device 130 before entering the RRC_INACTIVE state. The SDT configuration may indicate at least a data volume threshold and a SDT occasion. In the RRC_INACTIVE state, if a volume of data to be transmitted is below the data volume threshold, the third device 130 may determine the data is to be transmitted via the SDT. The third device 130 may then transmit the data at the SDT occasion.

The second device 120 and the fourth device 140 may communicate with each other via a channel such as a wireless communication channel. For example, the second device 120 and the fourth device 140 may communicate with each other via X2 or Xn interface. The second device 120 and the fourth device 140 may communicate with the first device 110 via a NR positioning protocol A (NRPPa) protocol. The third device 130 and the first device 110 may communicate with each other via an LTE positioning protocol (LPP) protocol.

It is also to be understood that the number of the first, second, third, and fourth devices as shown in FIG. 1 are only for the purpose of illustration without suggesting any limitations. The network 100 may include any suitable number of first second, third, and fourth devices adapted for implementing embodiments of the present disclosure.

Only for ease of discussion, the second device 120 and the fourth device 140 are illustrated as base stations and the third device 130 is illustrated as a UE. It is to be understood that base station and UE are only example implementations of the second device 120, the fourth device 140 and the third device 130, respectively, without suggesting any limitation as to the scope of the present application. Any other suitable implementations are possible as well.

The communications in the network 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

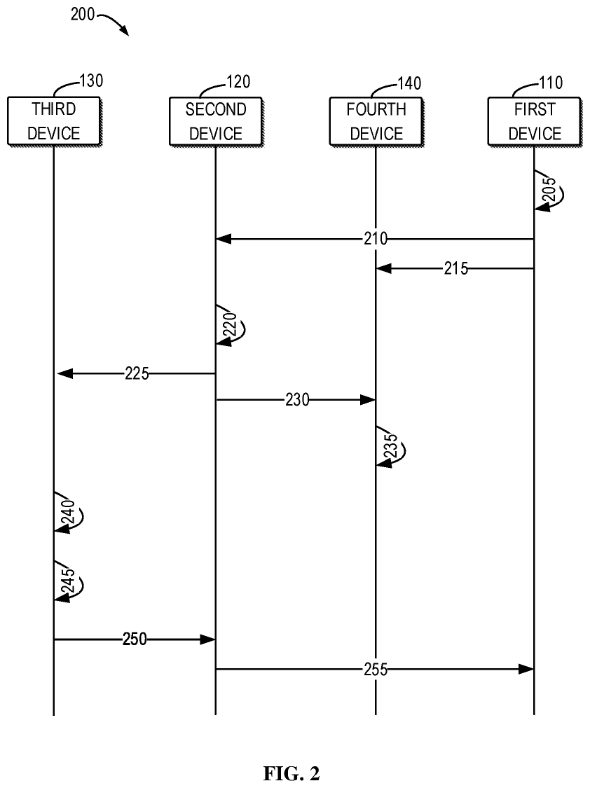

Principle and implementations of the present disclosure will be described in detail below with reference to FIGS. 2 to 6. FIG. 2 shows a signaling chart illustrating a positioning process 200 according to some example embodiments of the present disclosure. For the purpose of discussion, the process 200 will be described with reference to FIG. 2. The process 200 may involve the first device 110, the second device 120, a third device 130 and the fourth device 140.

As shown in FIG. 2, the first device 110 determines 205 that the third device 130 is to transmit a positioning related message in a non-connected state. The positioning related message may be a positioning measurement report or other positioning related message. The non-connected state may be the RRC_INACTIVE state or the RRC_IDLE state.

In some example embodiments, the first device 110 may determine that the third device 130 is about to transmit the positioning related message in the non-connected state based on a determination that the third device 130 is to enter the non-connected state.

In some example embodiments, the first device 110 may determine that the third device 130 is to enter the non-connected state based on the activity state of the third device 130. The activity state of the third device may be indicated from a message received from one of the AMF, the second device 120 or the third device 130. For example, upon determination of a low activity of the third device 130, the second device 120 may indicate to the first device 110 that the third device 130 is about to enter the RRC_INACTIVE state. Alternatively, the AMF may transmit an indication to the first device 110 indicating that the third device 130 is to enter the non-connected state.

The first device 110 transmits 210 assistance information to the second device 120 that serves the third device 130, for example, via the NRPPa protocol. The assistance information may include at least one of data size and a transmission periodicity for the positioning related message. In some example embodiments, the first device 110 may transmit 215 the assistance information to the fourth device 140 providing a neighbor cell 104 of the third device 130.

In some example embodiments, the first device 110 may transmit validity information on the assistance information to the second device 120. For example, the validity information may indicate a validity period of the assistance information for configuring SDT parameters. The validity period may be observed by a timer which will be started upon receipt or confirming the request. Upon expiration of the validity period, the second device 120 may not be requested by the first device 110 to provide SDT resources.

For example, the validity information may be per terminal device for a certain time period. For another example, the validity information may be per resource for a certain time period, for example, in terms of the reporting periodicity, the data size or the like. In a case, the second device 120 receives multiple parameter values with different validity information, it may optimize the resource allocation for the SDT.

In some example embodiments, the first device 110 may provide one or more information for assisting in determining the SDT configuration to the second device 120 as well as the fourth device 140. The information may include, but not limited to, the number of terminal devices expected to perform positioning in the non-connected state, the number of terminal devices per parameter category (e.g., requiring a specific periodicity, a data size, and the like), the minimum data size supported by SDT resource for positioning, the minimum periodicity for the positioning related message and so on.

In some example embodiments, the third device 130 may also transmit the assistance information to the second device 120, for example, via a RRC message. In these embodiments, the second device 120 may further transmit the assistance information to the fourth device 140 as well as other TRPs in the same RNA via a X2 or Xn interface.

Upon receipt of the assistance information from the first device 110, the second device 120 determines 220 a configuration for the positioning related message based on the assistance information. In some example embodiments, the positioning related message may be transmitted via the SDT procedure, and thus the configuration determined by the second device 120 may be the SDT configuration.

In some example embodiments, the second device 120 may determine at least one of the following based on the data size:
time and frequency resource allocation, for example, a resource allocated for a first message associated with the SDT, the first message includes, but not limited to, a message A that is a random access preamble in 2-step random access procedure for the SDT, a message 3 in 4-step random access procedure for the SDT, and a message that is an uplink configured grant (UL CG) for SDT;
the Modulation and Coding Scheme (MCS) for the first message; and
a data volume threshold for the third device 130 to determine whether the SDT is to be used.

In some example embodiments, the second device 120 may determine a SDT occasion for the third device 130 to transmit the positioning related message in the non-connected state based on the transmission periodicity.

The second device 120 transmits 225 the configuration to the third device 130 for transmitting the positioning related message in the RRC NON-CONNECTED state. In some example embodiments, the second device 120 may also transmit 230 the configuration to the fourth device 140.

Upon receipt the assistance information, the fourth device 140 reserves 235 a resource based on the assistance information. For example, the fourth device 140 may use the same or similar configuration for the SDT. The fourth device 140 may attempt to receive the positioning related message from the third device 130 on the reserved resource. For another example, the fourth device 140 may avoid allocating the reserved resource for other transmissions.

In some example embodiments, the third device 130 may provide other information to the second device 120 for determining the configuration, such as, the preferred transmit (Tx) beam. As an example, before entering the RRC NON-CONNECTED state, the third device 130 may be configured to provide such information via up to N DL reference signals (RS), such as, synchronization signaling blocks (SSB), that it has detected or measured. The SSB is assumed to be the spatial relation RS corresponding to the UL channel used for the SDT. The third device 130 may provide the information as part of the request to enter the RRC non-connected state for performing the positioning procedure.

In some example other embodiments, a network device may transmit a RRC message to the second device 120 for indicating a set of SDT resource specific to the positioning related message.

This may enable the network device to active a set of resources specific to the SDT instead of activating for the whole cell, and thus saving the resources, especially in FR2. In the above embodiments, the second device 120 may activate the configuration, and transmit an indication for activation of the configuration to the third device 130.

The third device 130 then enters 240 in the RRC NON-CONNECTED state. In the RRC NON-CONNECTED state, the third device 130 may determine whether the data volume of the positioning related message is below the data volume threshold. If the data volume of the positioning related message is below the data volume threshold, the third device 130 determines 245 the positioning related message is to be transmitted.

In this case, the third device 130 transmits 250 the positioning related message to the second device 120 based on the configuration. Upon receipt of the positioning related message via the SDT, the second device 120 may transmit 255 the positioning report to the first device 110.

It is to be understood that the positioning mechanism provided in the example embodiments is applicable to not only the positioning measurement report but also to other information to be transmitted between the terminal device and the LMF in the RRC NON-CONNECTED state. Moreover, such a mechanism is suitable for both the UE based positioning and the UE assisted positioning.

According to the example embodiments of the present disclosure, a proactive knowledge related to positioning is provided to the base station. Hence, appropriate SDT configurations can be determined and resources with a suitable size and periodicity can be allocated or reserved for the SDT that is used for transmitting the positioning related message in the RRC NON-CONNECTED state. As such, the efficiency of SDT procedure can be improved, while avoiding segmentation or subsequent transmission of the positioning report.

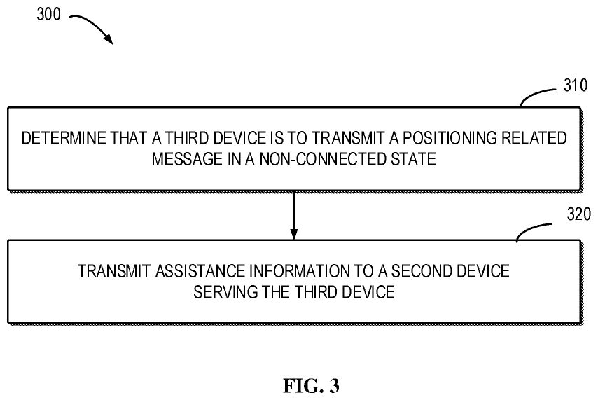

Corresponding to the process described in connection with FIG. 2, embodiments of the present disclosure provide a solution for positioning involving the location management function node, the network device providing the serving cell, the terminal device, and the network device providing the neighbor cell. These methods will be described below with reference to FIGS. 3 to 6.

FIG. 3 illustrates a flowchart of a method 300 for positioning implemented at a location management function node according to example embodiments of the present disclosure. The method 300 can be implemented at the first device 110 shown in FIG. 1. For the purpose of discussion, the method 300 will be described with reference to FIG. 1. It is to be understood that method 300 may further include additional blocks not shown and/or omit some shown blocks, and the scope of the present disclosure is not limited in this regard.

As shown in FIG. 3, at block 310, the first device 110 determines that the third device 130 is to transmit a positioning related message in a non-connected state. In some example embodiments, the positioning related message may be transmitted via the SDT, and the positioning related message may be a positioning measurement report. The non-connected state may include the RRC_INACTIVE state or RRC_IDLE state.

In some example embodiments, the first device 110 may determine that the third device 130 is to enter the non-connected state, for example, based on the activity state (e.g., a low activity) of the third device 130 or an indication received from the AMF node. The activity state of the third device may be indicated from a first message received from one of the AMF, the second device 120 or the third device 130. In this case, the first device 110 may determine that the third device 130 is to transmit the positioning related message in the non-connected state.

At 320, the first device 110 transmits assistance information to the second device 120 that serves the third device 130. The assistance information may include at least one of data size and a transmission periodicity for the positioning related message.

In some example embodiments, the first device 110 may further transmit the assistance information to the fourth device 140 that provides a neighbor cell 104 of the third device 130. The first device 110 may transmit the assistance information via the NRPPa protocol.

According to the example embodiments of the present disclosure, the network node providing the positioning service, for example, the LMF transmits assistance information about a data size and transmission periodicity for the positioning related message to the base stations in the same RNA. With such proactive knowledge of the positioning related message, the base station is capable of determining appropriate configurations for the SDT procedure. The terminal device then transmits the positioning related message in the RRC NON-CONNECTED state via the SDT. As such, the efficiency of SDT procedure can be improved, while avoiding segmentation or subsequent transmission of the positioning report.

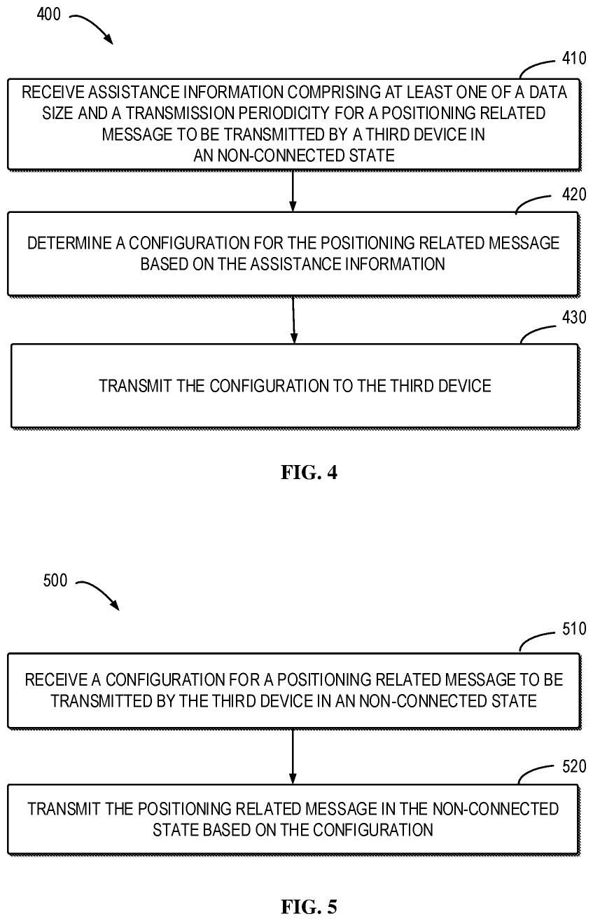

FIG. 4 illustrates a flowchart of a method 400 for positioning implemented at a network device according to example embodiments of the present disclosure. The method 400 can be implemented at the second device 120 shown in FIG. 1. For the purpose of discussion, the method 400 will be described with reference to FIG. 1. It is to be understood that method 400 may further include additional blocks not shown and/or omit some shown blocks, and the scope of the present disclosure is not limited in this regard.

As shown in FIG. 4, at block 410, the second device 120 receives assistance information from the first device 110. The assistance information may include at least one of a data size and a transmission periodicity for the positioning related message to be transmitted by the third device 130 in the non-connected state. The non-connected state may be the RRC_INACTIVE state or RRC_IDLE state.

At block 420, the second device 120 determines a configuration for the positioning related message based on the assistance information. By way of example, the positioning related message may be transmitted via SDT, and thus the configuration may be associated with the SDT procedure, that is, the SDT configuration.

In some example embodiments, the second device 120 may determine, based on the data size, at least one of a resource allocated for a first message associated with the SDT, the MCS for the first message, or a data volume threshold for the third device 130 to determine whether the SDT is to be used. In these embodiments, the first message may by a message A that includes a random access preamble in 2-step random access procedure for the SDT, a message 3 in 4-step random access procedure for the SDT, or a message that include the UL CG for the SDT.

In some example embodiments, the second device 120 may determine, based on the transmission periodicity, the SDT occasion for the third device 130 to transmit the positioning related message in the non-connected state.

At block 430, the second device 120 transmits the configuration to the third device 130. In some example embodiment, the second device 120 may further transmit the configuration to the fourth device 140 that provides a neighbor cell 104 of the third device 130. For example, the second device 120 may transmit the configuration to the fourth device 140 via X2 or Xn interface.

In some example embodiments, the second device 120 may activate the configuration and transmit an indication of the activation of the configuration to the third device 130. For example, the second device 120 may determine to activate the configuration based on a low activity of the third device 130.

In the above embodiments, by way of example, the second device 120 may receive an indication from the third device 130 that indicates the third device 130 is to transmit the positioning related message in the non-connected state. In this case, the second device 120 may activate the allocated resource.

In the above embodiments, by way of another example, the second device 120 may receive, for example, a RRC release message from a network device indicating that a set of resources for performing the SDT are activated and the set of resources include the allocated resource. In this case, the second device 120 may activate the allocated resource.

In the above embodiments, by way of another example, the second device 120 may receive an activation indication from the first device 110 via a RRC message. In this case, the second device 120 may activate the allocated resource.

In some example embodiments, the second device 120 may transmit an indication indicating that the third device 130 is to enter the non-connected state to the first device 110.

In some example embodiments, the second device 120 may receive, from the third device 130, the positioning related message via the SDT. The second device 120 may then transmit the positioning related message to the first device 110.

According to the example embodiments of the present disclosure, a proactive knowledge related to positioning is provided to the last serving base station. As such, the base station is capable of determining appropriate configurations for the SDT procedure that is used by the terminal device for transmitting the positioning related message in the RRC NON-CONNECTED state. As such, the efficiency of SDT procedure can be improved, while avoiding segmentation or subsequent transmission of the positioning report.

FIG. 5 illustrates a flowchart of a method 500 for positioning implemented at a terminal device according to example embodiments of the present disclosure. The method 500 can be implemented at the third device 130 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

As shown in FIG. 5, at block 510, the third device 130 receives, from the second device 120, a configuration for a positioning related message to be transmitted by the third device 130 in a non-connected state. The configuration may be determined at the second device 120 based on assistance information received from the first device 110. The assistance information may include at least one of a data size and a transmission periodicity for the positioning related message.

In some example embodiments, the configuration may indicate at least one of a resource allocated by the second device 120, the MCS, the transmission occasion for transmitting the positioning related message and the like. For example, the positioning related message may be transmitted via the SDT procedure, and in this case, the configuration may be the SDT configuration.

In some example embodiments, the third device 130 may transmit, to the second device 120, an indication indicating that the third device 130 is about to transmit the positioning related message in the non-connected state. The non-connected state may be the RRC_INACTIVE state or the RRC_IDLE state.

The third device 130 may also provide such assistance information to the second device 120. For example, when the third device 130 is about to operate in RRC_INACTIVE state, the third device 130 may transmit the assistance information to its serving base station, e.g., the second device 120, via a high layer signaling, such as, the RRC message. The second device 120 may further transmit the assistance information to other network devices in the same RNA, such as, the fourth device 140.

In some example embodiments, the third device 130 may provide other information to the second device 120 for assisting in determining the resource for the SDT, for example, the preferred transmit beam. As an example, before entering the RRC non-connected state, the third device 130 may be configured to provide such information via up to N DL reference signals (RS), such as, synchronization signaling blocks (SSB), that it has detected or measured. The SSB is assumed to be the spatial relation RS corresponding to the UL channel used for the SDT. The third device 130 may provide the information as part of the request to enter the RRC non-connected state for performing the positioning procedure. This may enable the network device to active specific set of resources for the SDT instead of activating for the whole cell, and thus saving the resources, especially in FR2.

At block 520, the third device 130 transmits, in the non-connected state and to the second device 120, the positioning related message based on the configuration. The positioning related message may be the positioning measurement report. In some example embodiments, the third device 130 may further transmit the positioning related message to the first device 110.

In some example embodiments, the positioning related message may be transmitted via the SDT procedure. In these embodiments, the third device 130 may obtain a data volume threshold associated with the SDT from the configuration. If the data volume of the positioning related message is below the data volume threshold, the third device 130 may determine that the positioning related message is to be transmitted. In this case, the third device 130 may transmit the positioning related message based on the configuration indicating at least one of: the resource allocated for a first message associated with the SDT, the MCS for the first message, or a SDT occasion comprising one of a random access procedure occasion, or an UL CG occasion.

Alternatively, in a case where the third device 130 may have moved outside the cell 102 of the second device 120, and within the cell 104 of the fourth device 140, the third device 130 may transmit the positioning related message to the fourth device 140.

According to the example embodiments of the present disclosure, the terminal device is provided with a positioning mechanism in the RRC NON-CONNECTED state. By means of assistance information related to the positioning related message, the base station can assign appropriate configuration for SDT in terms of data size and periodicity. The terminal device then transmits the positioning related message in the RRC NON-CONNECTED state via the SDT.

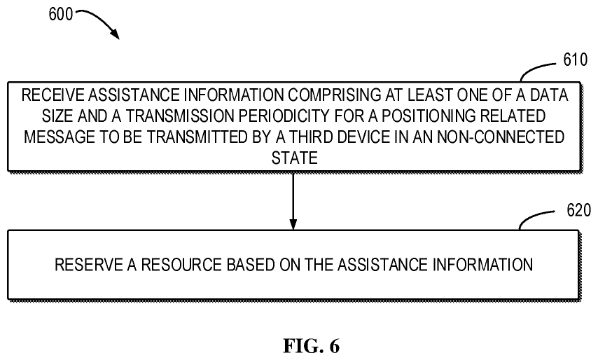

FIG. 6 illustrates a flowchart of a method 600 for positioning implemented at a network device according to example embodiments of the present disclosure. The method 600 can be implemented at the fourth device 140 shown in FIG. 1. For the purpose of discussion, the method 600 will be described with reference to FIG. 1. It is to be understood that method 160 may further include additional blocks not shown and/or omit some shown blocks, and the scope of the present disclosure is not limited in this regard.

As shown in FIG. 6, at block 610, the fourth device 140 receives assistance information from the first device 110. The assistance information may include at least one of a data size and a transmission periodicity for a positioning related message to be transmitted by the third device 130 in an non-connected state. The non-connected state may be RRC_INACTIVE state or RRC_IDLE state.

The assistance information may be provided by the first device 110 due to the third device 130 in a low activity state. For example, the second device 120 that serves the third device 130 may indicate to the first device 110 that the third device 130 is about to enter the RRC NON-CONNECTED state. Alternatively, assistance information may be provided by the first device 110 in response to the request for the positioning related message. In these cases, the first device 110 may provide the assistance information to the second device 120 as well as the fourth device 140 or other transmission and reception point (TRP) within the same RNA.

In some other embodiments, the fourth device 140 may receive the assistance information from the second device 120. Specifically, the second device 120 may receive such information from the first device 110 as described above, or alternatively, from the third device 130. For example, the third device 130, when it is in the RRC NON-CONNECTED state, may transmit the assistance information via a RRC message. The second device 120 may then transmit the assistance information to the other network devices or TRPs including the fourth device 140 in the same RAN via X2 or Xn interface.

In some example embodiments, the fourth device 140 may receive, from the second device 120, a configuration for the positioning related message. The configuration may be determined at the second device 120 based on the assistance information and the positioning related message transmitted via the SDT.

At block 620, the fourth device 140 reserves a resource based on the assistance information. In some example embodiments, the fourth device 140 may attempt to receive the positioning related message from the third device 130 on the reserved resource. For example, the fourth device 140 may avoid using the resource for other data transmission.

In some example embodiments, the fourth device 140 may receive the positioning related message from the third device 130 transmitted on the reserved resource. The positioning related message may include a positioning measurement report.

The embodiments of the present disclosure provide a solution for positioning the terminal device in the RRC NON-CONNECTED state. In the solution, assistance information is provided to the serving network device to assign appropriate resources for SDT. The assistance information may indicate at least one of the data size, amount, periodicity, interval associated with the positioning report and the like. The serving base station then determines SDT configuration suitable for positioning report based on the assistance information.

With the SDT configuration, the terminal device can transmit a positioning related message in a non-connected state. Such a solution is applicable for both UE assisted positioning and UE based positioning. Of course, this solution can also be applied for transmitting other information from the terminal device to the LMF in the non-connected state.

In some example embodiments, a first apparatus capable of performing any of the method 300 (for example, the first device 110) may comprise means for performing the respective steps of the method 300. The means may be implemented in any suitable form. For example, the means may be implemented in a circuitry or software module.

In some example embodiments, the first apparatus comprises: means for determining that a third device is to transmit a positioning related message in a non-connected state; and means for transmitting assistance information to a second device serving the third device, the assistance information comprising at least one of data size and a transmission periodicity for the positioning related message.

In some example embodiments, the means for transmitting the positioning related message in the non-connected state further comprises: means for in accordance with a determination that the third device is to enter the non-connected state, determining that the third device is to transmit the positioning related message in the non-connected state.

In some example embodiments, the first apparatus further comprises: means for determine that the third device is to enter the non-connected state based on at least one of: an activity state of the third device; or an indication received from an access and mobility management function node.

In some example embodiments, the activity state of the third device is indicated in a message received from one of the access and mobility management function node, the second device and the third device.

In some example embodiments, the positioning related message is to be transmitted via a small data transmission, and the positioning related message comprises a positioning measurement report.

In some example embodiments, the first apparatus further comprises: means for transmitting the assistance information to a fourth device providing a neighbor cell of the third device.

In some example embodiments, the means for transmitting the assistance information further comprises: means for transmitting the assistance information via a NR Positioning Protocol A, NRPPa, protocol.

In some example embodiments, the non-connected state comprises one of a radio resource control, RRC, inactive state or a RRC idle state.

In some example embodiments, the first apparatus comprises a location management function node, the second device comprises a network device, and the third device comprises a terminal device.

In some example embodiments, a second apparatus capable of performing any of the method 400 (for example, the second device 120) may comprise means for performing the respective steps of the method 400. The means may be implemented in any suitable form. For example, the means may be implemented in a circuitry or software module.

In some example embodiments, the second apparatus comprises: means for receiving assistance information from a first device, the assistance information comprising at least one of a data size and a transmission periodicity for a positioning related message to be transmitted by a third device in an non-connected state; means for determining a configuration for the positioning related message based on the assistance information; and means for transmitting the configuration to the third device.

In some example embodiments, the means for determining the configuration for the positioning related message further comprises: means for performing at least one of determining, based on the data size, at least one of the following: a resource allocated for a first message associated with a small data transmission, a modulation and coding scheme for the first message, or a data volume threshold for the third device to determine whether the small data transmission is to be used; or determining, based on the transmission periodicity, a small data transmission occasion for the third device to transmit the positioning related message in the non-connected state.

In some example embodiments, the first message comprises: a message A comprising a random access preamble in 2-step random access procedure for the small data transmission, a message 3 in 4-step random access procedure for the small data transmission, or a message comprising an uplink configured grant for the small data transmission.

In some example embodiments, the fourth apparatus may further comprise: means for transmitting the configuration to a fourth device providing a neighbor cell of the third device.

In some example embodiments, the configuration is transmitted via an Xn interface.

In some example embodiments, the fourth apparatus may further comprise: means for receiving, from the third device, the positioning related message via a small data transmission; and means for transmitting the positioning related message to the first device.

In some example embodiments, the second apparatus may further comprise: means for activating the configuration; and means for transmitting, to the third device, an indication of the activation of the configuration.

In some example embodiments, the second apparatus may further comprise: means for in response to receiving, from the third device, an indication indicating that the third device is to transmit the positioning related message in the non-connected state, activating the allocated resource; in response to receiving, from a network device, a message indicating that a set of resources for performing a small data transmission are activated and the set of resources comprise the allocated resource, activating the allocated resource; or in response to receiving an activation indication from the first device, activating the allocated resource.

In some example embodiments, the second apparatus may further comprise: means for transmitting, to the first device, an indication indicating that the third device is to enter the non-connected state.

In some example embodiments, the positioning related message comprises a positioning measurement report and the non-connected state comprises one of a radio resource control, RRC, inactive state or a RRC idle state.

In some example embodiments, the first device comprises a location management function node, the second apparatus comprises a network device, and the third device comprises a terminal device.

In some example embodiments, a third apparatus capable of performing any of the method 500 (for example, the third device 130) may comprise means for performing the respective steps of the method 500. The means may be implemented in any suitable form. For example, the means may be implemented in a circuitry or software module.

In some example embodiments, the third apparatus comprises means for receiving, from a second device, a configuration for a positioning related message to be transmitted by the third device in an non-connected state, the configuration being determined at the second device based on assistance information received from a first device, the assistance information comprising at least one of a data size and a transmission periodicity for the positioning related message; and means for transmitting, in the non-connected state and to the second device, the positioning related message based on the configuration.

In some example embodiments, the means for transmitting the positioning related message further comprises: means for obtaining, from the configuration, a data volume threshold associated with a small data transmission; means for in accordance with a determination that a data volume of the positioning related message is below the data volume threshold, determining that the positioning related message is to be transmitted via the small data transmission; and means for transmitting the positioning related message based on the configuration indicating at least one of: a resource allocated for a first message associated with the small date transmission, a modulation and coding scheme for the first message, or a small data transmission occasion comprising one of a random access procedure occasion, or an uplink configured grant occasion.

In some example embodiments, the third apparatus further comprises means for transmitting, to the second device, an indication indicating that the third apparatus is about to transmit the positioning related message in the non-connected state.

In some example embodiments, the positioning related message comprises a positioning measurement report and the non-connected state comprises one of a radio resource control, RRC, inactive state or a RRC idle state.

In some example embodiments, the third apparatus further comprises means for transmitting the positioning related message to the first device.

In some example embodiments, the first device comprises a location management function node, the second device comprises a network device, and the third apparatus comprises a terminal device.

In some example embodiments, a fourth apparatus capable of performing any of the method 600 (for example, the fourth device 140) may comprise means for performing the respective steps of the method 600. The means may be implemented in any suitable form. For example, the means may be implemented in a circuitry or software module.

In some example embodiments, the fourth apparatus comprises means for receiving assistance information from a first device, the assistance information comprising at least one of a data size and a transmission periodicity for a positioning related message to be transmitted by a third device in an non-connected state; and means for reserving a resource based on the assistance information.

In some example embodiments, the fourth apparatus may further comprise means for receiving, from a second device, a configuration for the positioning related message, the configuration being determined at the second device based on the assistance information and the positioning related message being transmitted via a small data transmission.

In some example embodiments, the second device serves the third device, the fourth device provides a neighbor cell of the third device, and the fourth apparatus may further comprise means for attempting to receive the positioning related message from the third device on the reserved resource.

In some example embodiments, the positioning related message comprises a positioning measurement report and the non-connected state comprises one of a radio resource control, RRC, inactive state or a RRC idle state.

In some example embodiments, the first device comprises a location management function node, the second device comprises a network device, the third device comprises a terminal device, and the fourth apparatus comprises a further network device.

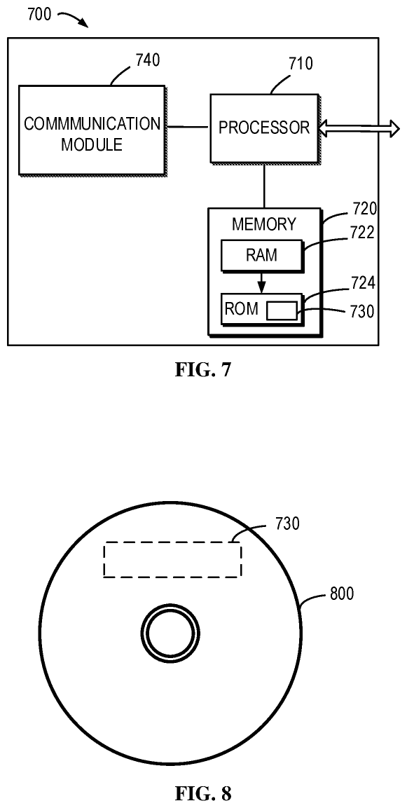

FIG. 7 is a simplified block diagram of a device 700 that is suitable for implementing embodiments of the present disclosure. The device 700 may be provided to implement the communication device, for example the location management device 110, the network device 120, the terminal device 130, or the network device 140 as shown in FIG. 2. As shown, the device 700 includes one or more processors 710, one or more memories 720 coupled to the processor 710, and one or more transmitters and receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 720. The processor 710 may perform any suitable actions and processing by loading the program 730 into the RAM 720.

The embodiments of the present disclosure may be implemented by means of the program 730 so that the device 700 may perform any process of the disclosure as discussed with reference to FIGS. 3-6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300, 400, 500 and 600 as described above with reference to FIGS. 3-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-40. (canceled)

41. A first device, comprising:
at least one processor; and
at least one memory including computer program code;
wherein the at least one memory and the computer program code are configured to, with the at least one processor, cause the first device to:
determine that a third device is to transmit a positioning related message in a non-connected state; and
transmit assistance information to a second device serving the third device, the assistance information comprising at least one of data size and a transmission periodicity for the positioning related message.

42. The first device of claim 41, wherein the at least one memory and the computer program code are configured to, with the at least one processor, cause the first device to determine that the third device is to transmit the positioning related message in the non-connected state by:
in accordance with a determination that the third device is to enter the non-connected state, determining that the third device is to transmit the positioning related message in the non-connected state.

43. The first device of claim 41, wherein the at least one memory and the computer program code are configured to, with the at least one processor, further cause the first device to:
determine that the third device is to enter the non-connected state based on at least one of:
an activity state of the third device; or
an indication received from an access and mobility management function node.

44. The first device of claim 43, wherein the activity state of the third device is indicated in a message received from one of the access and mobility management function node, the second device and the third device.

45. The first device of claim 41, wherein the positioning related message is to be transmitted via a small data transmission, and the positioning related message comprises a positioning measurement report.

46. The first device of claim 41, wherein the at least one memory and the computer program code are configured to, with the at least one processor, further cause the first device to:
transmit, via a NR Positioning Protocol A protocol, the assistance information to a fourth device providing a neighbor cell of the third device.

47. A second device, comprising:
at least one processor; and
at least one memory including computer program code;
wherein the at least one memory and the computer program code are configured to, with the at least one processor, cause the second device to:
receive assistance information from a first device, the assistance information comprising at least one of a data size and a transmission periodicity for a positioning related message to be transmitted by a third device in an non-connected state;
determine a configuration for the positioning related message based on the assistance information; and
transmit the configuration to the third device.

48. The second device of claim 47, wherein the at least one memory and the computer program code are configured to, with the at least one processor, cause the second device to determine the configuration for the positioning related message by performing at least one of:
determining, based on the data size, at least one of the following:
a resource allocated for a first message associated with a small data transmission,
a modulation and coding scheme for the first message, or
a data volume threshold for the third device to determine whether the small data transmission is to be used; or
determining, based on the transmission periodicity, a small data transmission occasion for the third device to transmit the positioning related message in the non-connected state.

49. The second device of claim 48, wherein the first message comprises:
a message A comprising a random access preamble in 2-step random access procedure for the small data transmission,
a message 3 in 4-step random access procedure for the small data transmission, or
a message comprising an uplink configured grant for the small data transmission.

50. The second device of claim 47, wherein the at least one memory and the computer program code are configured to, with the at least one processor, further cause the second device to:
transmit, via an Xn interface, the configuration to a fourth device providing a neighbor cell of the third device.

51. The second device of claim 47, wherein the at least one memory and the computer program code are configured to, with the at least one processor, further cause the second device to:
receive, from the third device, the positioning related message via a small data transmission; and
transmitting the positioning related message to the first device.

52. The second device of claim 47, wherein the at least one memory and the computer program code are configured to, with the at least one processor, further cause the second device to:
activate the configuration; and
transmit, to the third device, an indication of the activation of the configuration; and
transmit, to the first device, an indication indicating that the third device is to enter the non-connected state.

53. The second device of claim 52, wherein the at least one memory and the computer program code are configured to, with the at least one processor, cause the second device to activate the configuration by:
in response to receiving, from the third device, an indication indicating that the third device is to transmit the positioning related message in the non-connected state, activating the allocated resource;
in response to receiving, from a network device, a message indicating that a set of resources for performing a small data transmission are activated and the set of resources comprise the allocated resource, activating the allocated resource; or
in response to receiving an activation indication from the first device, activating the allocated resource.

54. A third device comprising:
at least one processor; and
at least one memory including computer program code;
wherein the at least one memory and the computer program code are configured to, with the at least one processor, cause the third device to:
receive, from a second device, a configuration for a positioning related message to be transmitted by the third device in a non-connected state, the configuration being determined at the second device based on assistance information received from a first device, the assistance information comprising at least one of a data size and a transmission periodicity for the positioning related message; and
transmit, in the non-connected state and to the second device, the positioning related message based on the configuration.

55. The third device of claim 54, wherein the at least one memory and the computer program code are configured to, with the at least one processor, further cause the third device to transmit the positioning related message by:
obtaining, from the configuration, a data volume threshold associated with a small data transmission;
in accordance with a determination that a data volume of the positioning related message is below the data volume threshold, determining that the positioning related message is to be transmitted via the small data transmission; and
transmitting the positioning related message based on the configuration indicating at least one of:
a resource allocated for a first message associated with the small date transmission,
a modulation and coding scheme for the first message, or
a small data transmission occasion comprising one of a random access procedure occasion, or an uplink configured grant occasion.

56. The third device of claim 54, wherein the at least one memory and the computer program code are configured to, with the at least one processor, further cause the third device to:
transmit, to the second device, an indication indicating that the third device is about to transmit the positioning related message in the non-connected state; and
transmit, to the first device, the positioning related message.

57. A fourth device comprising:
at least one processor; and
at least one memory including computer program code;
wherein the at least one memory and the computer program code are configured to, with the at least one processor, cause the fourth device to:
receive assistance information from a first device, the assistance information comprising at least one of a data size and a transmission periodicity for a positioning related message to be transmitted by a third device in an non-connected state; and
reserve a resource based on the assistance information.

58. The fourth device of claim 57, wherein the at least one memory and the computer program code are configured to, with the at least one processor, further cause the fourth device to:
receive, from a second device, a configuration for the positioning related message, the configuration being determined at the second device based on the assistance information and the positioning related message being transmitted via a small data transmission.

59. The fourth device of claim 57, wherein the second device serves the third device, the fourth device provides a neighbor cell of the third device, and the at least one memory and the computer program code are configured to, with the at least one processor, cause the fourth device to reserve resources by:
attempting to receive the positioning related message from the third device on the reserved resources.

60. The fourth device of claim 57, wherein the first device comprises a location management function node, the second device comprises a network device, the third device comprises a terminal device, and the fourth device comprises a further network device.
